(19) United States
(12) Patent Application Publication
(10) Pub. No.: US 2007/0208468 A1
(43) Pub. Date: Sep. 6, 2007

(54) INFORMATION DISPLAY AND METHOD OF DISPLAYING INFORMATION FOR A VEHICLE

(75) Inventors: Venkateswa Sankaran, Farmington Hills, MI (US); Steven Chorian, Canton, MI (US); Eric Schaeffer, Farmington Hills, MI (US); Lixin Situ, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/570,063

(22) PCT Filed: Jun. 30, 2004
(86) PCT No.: PCT/US04/21084

§ 371 Date: Dec. 5, 2006

(51) Int. Cl. G01M 17/00

(52) U.S. Cl. 701/29; 903/907

(57) ABSTRACT

A vehicle information display (56) for a hybrid electric vehicle is provided. The display (56) includes an engine icon (60), a motor icon (62), a battery icon (64) and a vehicle drive wheels icon (66). To provide information to the vehicle operator regarding the operating state of the vehicle, power flow indicators (68, 70, 72) between the various icons are used to indicate the direction and magnitude of power flow between corresponding components of the vehicle.

### BACKGROUND OF THE INVENTION

1. Field of the Invention

The present invention relates to an information display and a method of displaying information for a vehicle.

2. Background Art

Conventional vehicles, such as those powered by a single internal combustion engine, often provide a vehicle operator with information through a number of commonly used displays. For example, speedometers, odometers, tachometers, fuel level gauges, oil level indicators and engine temperature gauges are commonly used to provide information in analog and/or digital form. With the increase in prevalence of non-conventional vehicles—e.g., fuel cell vehicles and hybrid electric vehicles (HEV)—a need has arisen to provide a vehicle operator with additional information unique to these non-conventional vehicles.

A vehicle having both an engine and a motor may be powered by either one or both of these torque-producing devices. In addition, the electric motor may act as a generator to charge an energy storage device, such as a battery or capacitor. In some vehicles, a motor and generator may be combined, while in others, a generator may be provided separately from a drive motor. In these types of vehicles, it may be beneficial to provide a vehicle operator with information regarding the flow of power between these various devices, and to and from the vehicle wheels. Such information may be important to the operation of the vehicle; moreover, it may also provide a vehicle operator with a better understanding of the operation of the non-conventional vehicle.

One attempt to provide such a display for a fuel cell vehicle is found in U.S. Patent Application Publication No. 20030137278 (Kondo), published on Jul. 24, 2003. The display device described in Kondo provides an operator of a fuel cell vehicle with information regarding the operation of the vehicle. For example, a capacitometer indicates the residual capacity of a capacitor, and also whether the capacitor is being charged. In addition, a motor output meter is used to indicate the power output from the motor, and what portion of that power comes from the capacitor, and what portion comes from the fuel cell. The motor output meter also indicates when the motor is charging the capacitor. Each of these indicators uses colored lights in a linear or arcuate pattern to provide information to the vehicle operator.

One limitation of the display device described in Kondo is that the use of indicator lights in a linear or arcuate pattern does not place the information in context. That is, the display device described in Kondo does not provide a schematic representation of the vehicle, which would facilitate displaying the power flow into and out of the various devices. Such a schematic representation would provide a vehicle operator with an immediate grasp of which devices were outputting power and which devices were receiving power. With such a schematic representation, a vehicle operator would more quickly understand the operating state of the vehicle, and would be able to operate the vehicle accordingly.

Therefore, a need exists for a vehicle information display that provides an iconic representation of the vehicle, and displays the direction and relative magnitude of power flow between the various vehicle components.

### SUMMARY OF THE INVENTION

The present invention provides a vehicle information display that includes an iconic representation of the vehicle, and further, displays the magnitude and direction of the power flow between various components in the vehicle.

The invention also provides a vehicle information display for a vehicle having components including an electric machine arrangement, an energy storage device and vehicle drive wheels. The vehicle information display includes an iconic representation of the vehicle including a motor icon representing at least a portion of the electric machine arrangement, an energy storage device icon representing the energy storage device, and a vehicle drive wheels icon representing the vehicle drive wheels. A first power flow indicator is selectively displayed between the motor icon and the vehicle drive wheels icon to indicate a direction and relative magnitude of power being transferred between at least a portion of the electric machine arrangement and the vehicle drive wheels. A second power flow indicator is selectively displayed between the motor icon and the energy storage device icon to indicate a direction and relative magnitude of power being transferred between at least a portion of the electric machine arrangement and the energy storage device.

The invention further provides a method for displaying vehicle information; the vehicle includes an electric machine arrangement, an energy storage device, and vehicle drive wheels. The method includes displaying an iconic representation of the vehicle, including a motor icon representing at least a portion of the electric machine arrangement, an energy storage device icon representing the energy storage device, and a vehicle drive wheels icon representing the vehicle drive wheels. A first power flow indicator is selectively displayed between the motor icon and the vehicle drive wheels icon to indicate a direction and relative magnitude of power being transferred between at least a portion of the electric machine arrangement and the vehicle drive wheels. A second power flow indicator is selectively displayed between the motor icon and the energy storage device icon to indicate a direction and relative magnitude of power being transferred between at least a portion of the electric machine and the energy storage device.

The invention also provides a vehicle including an electric machine arrangement, an energy storage device, and vehicle drive wheels. The vehicle also includes a vehicle information display including a motor icon representing at least a portion of the electric machine arrangement, an energy storage device icon representing the energy storage device, and a vehicle drive wheels icon representing the vehicle drive wheels. The vehicle information display also includes power flow indicators configured to be selectively displayed to indicate a direction and relative magnitude of power being transferred between the energy storage device, the vehicle drive wheels, and at least a portion of the electric machine arrangement. At least one controller is configured to receive signals from the electric machine arrangement and the energy storage device, and to control operation of the vehicle information display.

### BRIEF DESCRIPTION OF THE DRAWINGS

FIG. 1 is a schematic representation of a vehicle in accordance with the present invention;

FIG. 2 is a schematic representation of a vehicle information display in accordance with the invention, indicating that the vehicle is in a hybrid drive state;

FIG. 3 is a schematic representation of the vehicle information display indicating that the vehicle is in an engine drive state;

FIG. 4 is a schematic representation of the vehicle information display, indicating that the vehicle is in an electric drive state;

FIG. 5 is a schematic representation of the vehicle information display, indicating that the vehicle is in an idle with charging state;

FIG. 6 is a schematic representation of the vehicle information display, indicating that the vehicle is in an idle state;

FIG. 7 is a schematic representation of the vehicle information display, indicating that the vehicle is in a charging HV battery state;

FIG. 8 is schematic representation of the vehicle information display showing a fuel consumption display; and

FIG. 9 is a flow chart showing the steps of a method in accordance with the present invention.

### DETAILED DESCRIPTION OF THE PREFERRED EMBODIMENTS

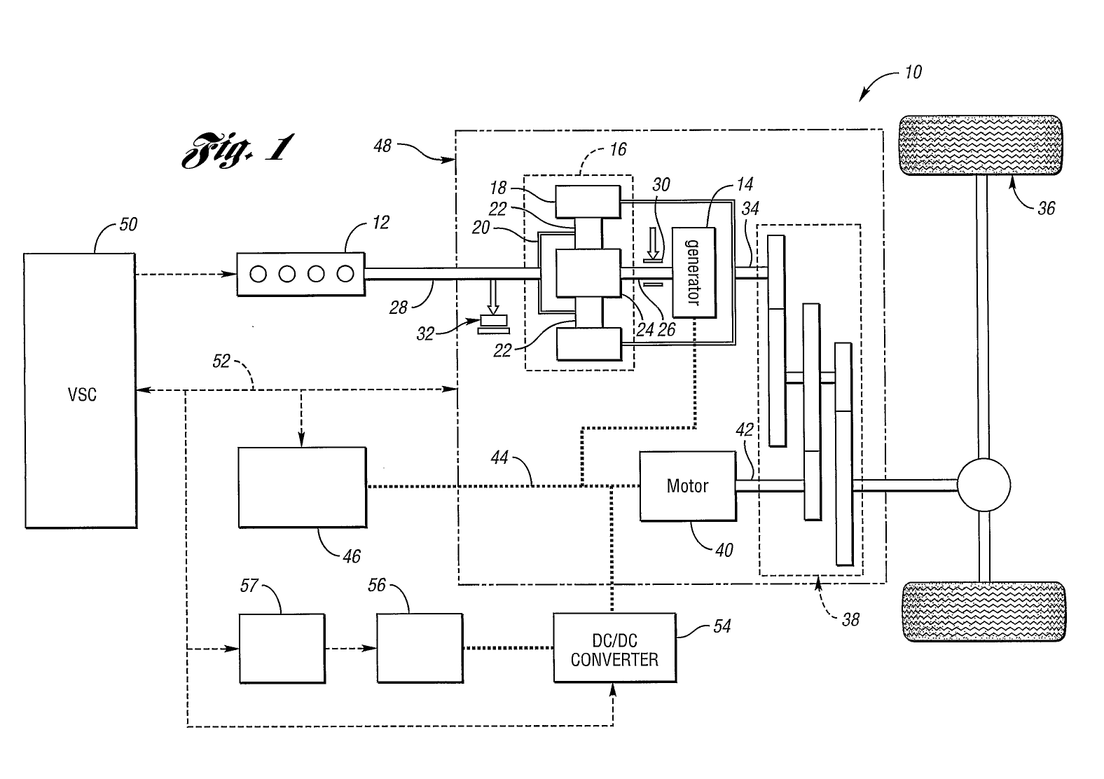

FIG. 1 shows a schematic representation of a vehicle 10 in accordance with the present invention. Although the vehicle 10 is an HEV, other types of vehicles are within the scope of the present invention—e.g., fuel cell vehicles, hybrid fuel cell vehicles, and pure electric vehicles. The vehicle 10 includes an engine 12 and a generator 14. The engine 12 and the generator 14 are connected through a power transfer unit, which in this embodiment is a planetary gear set 16. Of course, other types of power transfer units, including other gear sets and transmissions may be used to connect the engine 12 to the generator 14. The planetary gear set includes a ring gear 18, a carrier 20, planet gears 22, and a sun gear 24.

The generator 14 can also be used as a motor, outputting torque to a shaft 26 connected to the sun gear 24. Similarly, the engine 12 outputs torque to a shaft 28 connected to the carrier 20. A brake 30 is provided for stopping rotation of the shaft 26, thereby locking the sun gear 24 in place. Because this configuration allows torque to be transferred from the generator 14 to the engine 12, a one-way clutch 32 is provided so that the shaft 28 rotates in only one direction.

The ring gear 18 is connected to a shaft 34, which is connected to vehicle drive wheels 36 through a second gear set 38. The vehicle 10 includes a motor 40 which can be used to output torque to a shaft 42. The two electric machines—i.e., the motor 40 and the generator 14—make up an electric machine arrangement. Thus, as used herein, the motor 40 and the generator 14, each represent a portion of the electric machine arrangement. Of course, other vehicles may have different electric machine arrangements, such as more or less than two electric machines. In the embodiment shown in FIG. 1, the motor 40 and the generator 14 can both be used as motors to output torque. Alternatively, each can also be used as a generator, outputting electrical power to a high voltage bus 44 and to an energy storage device 46.

The energy storage device 46 is a high voltage battery that is also capable of outputting electrical power to operate the motor 40 and the generator 14. Other types of energy storage devices and/or output devices can be used with a vehicle, such as the vehicle 10. For example, the energy storage device 46 may be a capacitor, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear set 16, and a portion of the second gear set 38 may generally be referred to as a transaxle 48. To control the engine 12 and the components of the transaxle 48—i.e., the generator 14 and motor 40—a controller 50 is provided. As shown in FIG. 1, the controller 50 is a vehicle system controller (VSC), and although it is shown as a single controller, it may include multiple controllers. For example, the VSC 50 may include a separate powertrain control module (PCM), which could be software embedded within the VSC 50, or it could be a separate hardware device.

The VSC 50 communicates with the transaxle 48 and the battery 46 through a controller area network (CAN) 52. The various devices controlled by the VSC 50 may include their own controllers. For example, an engine control module (ECM) may communicate with the VSC 50 and may perform control functions on the engine 12. Similarly, the battery 46 may have a battery control module (BCM) that sends and receives signals to and from the VSC 50 and the battery 46. The transaxle 48 may also include one or more controllers configured to control specific components within the transaxle 48, such as the generator 14 and/or the motor 40.

As shown in FIG. 1, the vehicle 10 also includes a DC/DC converter 54. The DC/DC converter 54 is connected to the high voltage bus 44. The DC/DC converter 54 reduces the voltage it receives, and outputs power at this lower voltage to a number of low voltage electrical devices on the vehicle 10. For example, an information display 56 may be provided with power through the DC/DC converter 54. The information display 56 may also receive information or data about the DC/DC converter 54 through the CAN 52.

The information display 56, is connected to a controller, or gateway 57. The gateway 57 communicates with the VSC 50, the battery 46, and the transaxle 48, and provides information to the information display 56. Signals output from the various components of the vehicle 10 can be processed, and display calculations can be performed, in the VSC 50, the gateway 57, the information display 56, or some combination of all three. Although the gateway 57 is shown in FIG. 1 as a separate controller, it may also be integrated directly into the VSC 50.

The information display 56 provides to a vehicle operator a variety of information about the vehicle 10. In doing so, it represents the vehicle 10 in a schematic, or iconic, representation. Such a representation provides the vehicle operator with a much better sense of how each of the various devices in the vehicle interact with one another, and is therefore more relevant than a mere analog or digital gauge that uses a needle or lighted indicators. FIG. 2 shows one of the possible display configurations for the information display 56. As shown in FIG. 2, an iconic representation 58 of the vehicle 10 includes an engine icon 60 which represents the engine 12, a motor icon 62 which selectively represents the motor 40 and the generator 14, an energy storage device icon, or battery icon 64, which represents the battery 46, and a vehicle drive wheels icon 66 which represents the vehicle drive wheels 36.

One function of the vehicle information display 56 is to indicate to the vehicle operator the direction and relative magnitude of power flows between various vehicle components—e.g., the engine 12, the generator 14, the motor 40, the battery 46, and the vehicle drive wheels 36. For example, a first power flow indicator, or motor power flow indicator 68, is selectively displayed between the motor icon 62 and the vehicle drive wheels icon 66 to indicate the direction and relative magnitude of power being transferred between the motor 40 and the vehicle drive wheels 36.

As shown in FIG. 2, the motor power flow indicator 68 is represented by an arrow having a tail and an arrowhead, with the arrowhead indicating that the direction of power flow is from the motor 40 to the vehicle wheels 36. In order to provide an indication of the relative magnitude of power being transferred from the motor 40 to the vehicle wheels 36, the motor power flow indicator is configured to be displayed with a number of different thicknesses. Specifically, as the power output from the motor 40 to the vehicle wheels 36 increases, the thickness of the motor power flow indicator 68 will increase. Similarly, as the power from the motor 40 to the vehicle wheels 36 decreases, the motor power flow indicator 68 will become thinner.

As shown in FIG. 2, the vehicle information display 56 also includes additional power flow indicators. For example, a second power flow indicator, or battery power flow indicator 70, is selectively displayed between the motor icon 62 and the battery icon 64 to indicate the direction and relative magnitude of power being transferred between the motor 40 and/or the generator 14 and the battery 46. A third power flow indicator, or generator power flow indicator 72, is selectively displayed between the engine icon 60 and the motor icon 62 to indicate the direction and relative magnitude of power being transferred between the engine 12 and the generator 14.

A fourth power flow indicator, or engine power flow indicator 68, is selectively displayed between the engine icon 60 and the vehicle drive wheels icon 66 to indicate the direction and relative magnitude of power being transferred between the engine 12 and the vehicle drive wheels 36. As with the motor power flow indicator 68, the other power flow indicators 70, 72, 74 are also shown as arrows having arrowheads to indicate the direction of power flow, and variable thicknesses to indicate the relative magnitude of the power flow.

As shown in FIG. 2, the engine icon 60, the motor icon 62, and the battery icon 64 each have a respective textual label 76, 78, 80 that indicates what each icon represents. In the case of the motor icon 62, the textual label is “electric motor”, though it is understood that the motor icon 62 represents both the motor 40 and the generator 14. Because the motor icon 62 represents both the motor 40 and the generator 14, certain protocols may be programmed into the VSC 50, the gateway 57, and/or the information display 56, to provide the appropriate display on the vehicle information display 56 when power is being transferred to or from the motor 40 and/or generator 14. For example, the interaction of the motor power flow indicator 68, the battery power flow indicator 70, and the generator power flow indicator 72 represents a special case, since some of the current from the high voltage bus 44 is being used by the DC/DC converter 54 to support low voltage loads in the vehicle 10. This current is not used in the power flow, and must be accounted for so that the power flow indicators 68, 70, 72 are not inaccurately represented on the vehicle information display 56.

To account for the current used by DC/DC converter 54, the motor power flow indicator 68, the battery power flow indicator 70, and the generator power flow indicator 72 will not be displayed alone. That is, if the VSC 50, the gateway 57, and/or the information display 56, receives signals that indicate that only one of the power flow indicators 68, 70, 72 is to be displayed, it is assumed that at least one of the motor 40, the generator 14, and the battery 46 is providing power to the DC/DC converter 54, and the single non-zero power flow indicator will not be displayed. If, however, at least two of the power flow indicators 68, 70, 72 are non-zero, and the non-zero power flow indicators represent a valid configuration, then each of the non-zero power flow indicators will be displayed. For example, if two non-zero power flow indicators would show power flowing into the motor icon 62, and no power flow indicators would show power flowing out, the configuration would be considered invalid, since the motor icon 62 does not represent an energy storage device.

To further reduce the complexity of the vehicle information display 56, while still providing relevant information to the vehicle operator, a protocol call be programmed into the VSC 50, the gateway 57, and/or the information display 56, such that a current display on the vehicle information display 56 will remain until it is replaced with another valid configuration. For example, if the vehicle 10 was in hybrid drive, as shown in FIG. 2, and the operation of the vehicle 10 changed such that only one of the power flow indicators 70, 72, 74 were non-zero, the display shown in FIG. 2 would remain until a new valid configuration was received by the VSC 50, the gateway 57, and/or the information display 56.

The vehicle information display 56 also includes a textual indicator 82 which indicates to the vehicle operator a state of operation of the vehicle 10 that corresponds to the transferred of power between the battery 46, the motor 40, the generator 14, the engine 12 and the vehicle drive wheels 36. Including such an indicator helps to familiarize the vehicle operator with the various states of operation of the vehicle 10. Thus, the iconic representation 58, combined with the textual indicator 82, provide the vehicle operator with an understanding of the vehicle 10 that text and gauges alone cannot provide.

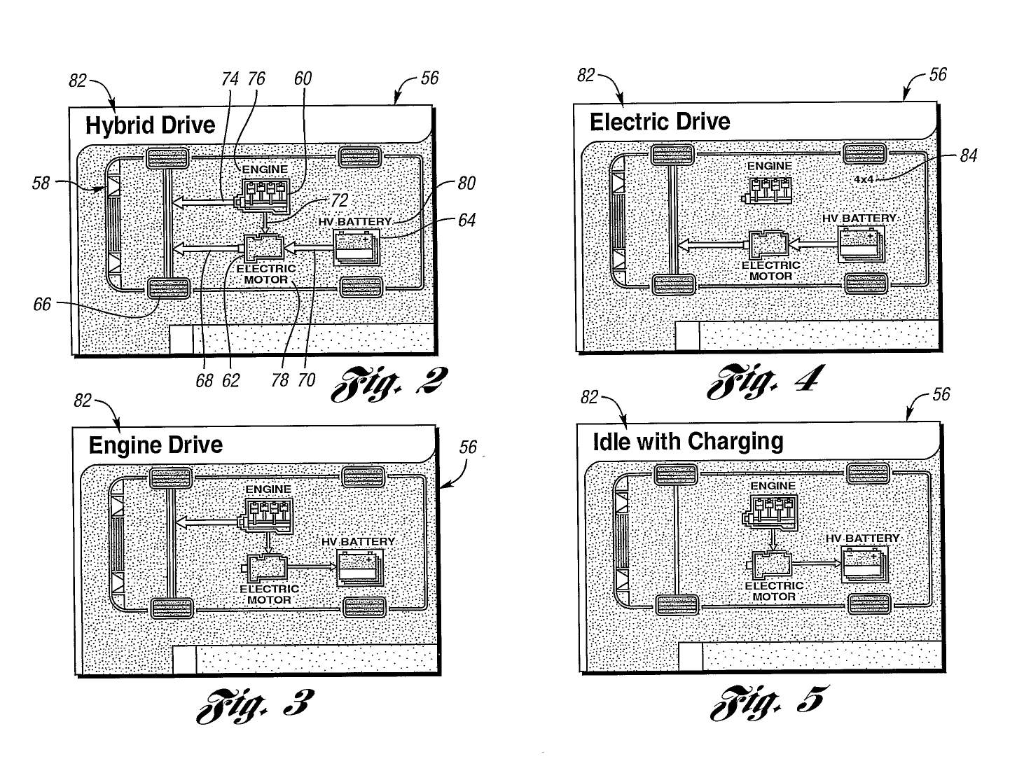

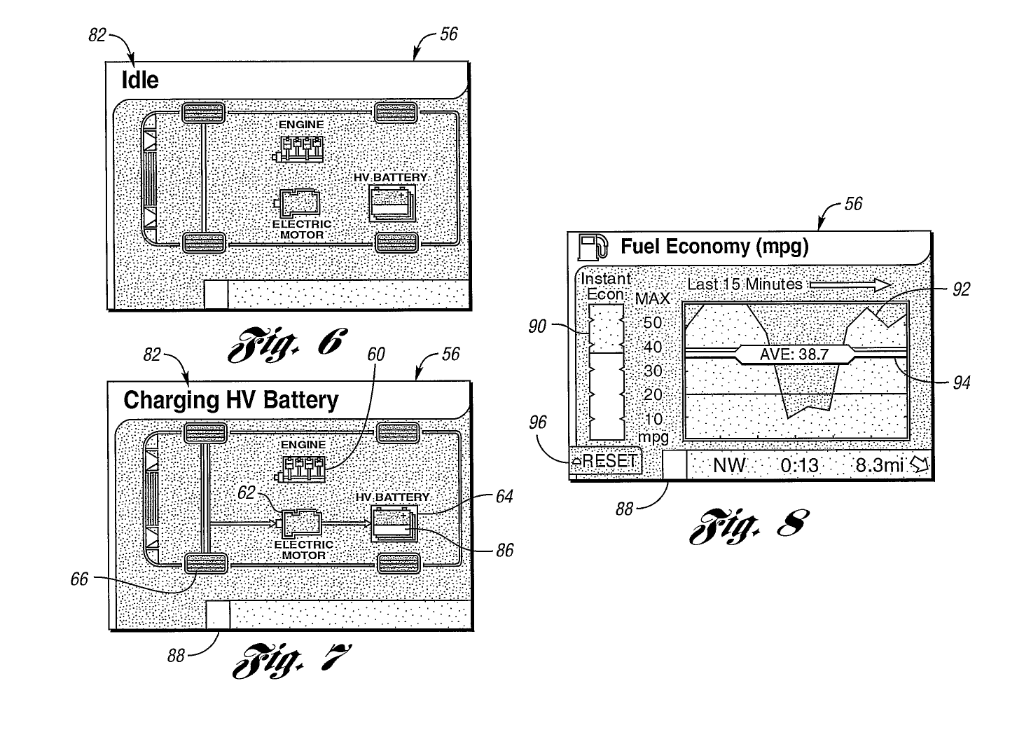

As shown in FIG. 2, the vehicle 10 is in a “hybrid drive” state, in which both the engine 12 and the motor 40 are contributing torque to the vehicle drive wheels 36. In FIG. 3, the textual indicator 82 indicates an “engine drive” state, in which only the engine 12 contributes torque to the vehicle drive wheels 36. FIG. 4 shows an “electric drive” state in which only the motor 40 contributes to the vehicle drive wheels 36. FIG. 4 also shows a four-wheel drive indicator 84 that indicates when torque is received by both sets of wheels on the vehicle 10. As shown in FIGS. 5 and 6, the vehicle information display 56 can indicate a number of different idle states. For example, FIG. 5 shows an “idle with charging” state, in which no torque is transferred to or from the vehicle drive wheels 36, but the generator 14 is charging the battery 46. Conversely, FIG. 6 shows a pure “idle” state, in which there is no power transfer between the engine 12, the generator 14, the motor 40, the battery 46 or the vehicle drive wheels 36.

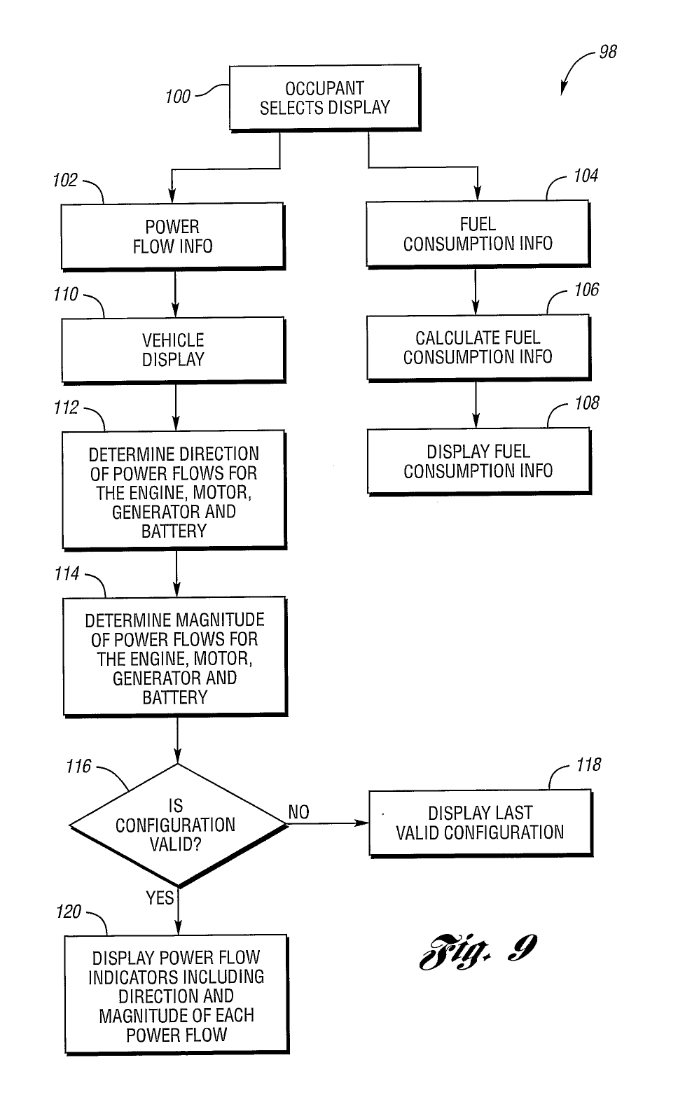

As discussed above, the energy storage device used on the vehicle 10 is a high voltage battery 46. Thus, FIG. 7 shows a “charging HV battery” state, in which torque is transferred from the vehicle drive wheels 36 to the generator 14 and/or motor 40, which in turn charge the battery 46. Also shown in FIG. 7, the vehicle drive wheels icon 66, the motor icon 62, and the battery icon 64 are highlighted. Highlighting an icon, or otherwise identifying an icon, can be done in different colors to provide different information about the vehicle component corresponding to the highlighted icon. For example, if an icon is highlighted, or otherwise identified with one color, such as orange, it can indicate that power is being transferred to or from the corresponding component—such is the case in FIG. 1. Conversely, an icon may be identified in a different color, such as red, for example, to indicate the presence of an anomalous condition in the corresponding vehicle component. The vehicle operator is thus informed that service may be necessary on that component.

As shown in FIG. 7, the battery icon 64 includes a shaded area 86. As the battery 46 is being charged, the shaded area 86 within the battery icon 64 will increase. The shaded area 86 indicates the relative state of charge of the battery 46, which gives the vehicle operator additional information regarding the state of the vehicle 10. The vehicle information display 56 also includes a mode switch 88, which, when actuated, causes the vehicle information display 56 to display fuel consumption information about the vehicle 10. The mode switch 88 may be configured as a tactile sensor on the display screen of the vehicle information display 56. FIG. 8 shows one possible configuration of the fuel consumption information that may be displayed when the mode switch 88 is actuated.

As shown in FIG. 8, a bar indicator 90 shows the vehicle operator the instantaneous fuel economy in miles per gallon (mpg). Of course, other units, such as liters per 100 kilometers (L/100 KM) can be used, so that the vehicle operator can switch between various units, depending on personal preference.

The fuel consumption display shown in FIG. 8 also includes a line graph 92 that shows the fuel economy in one minute increments for the last 15 minutes of driving. The information shown in the line graph 92 is cleared whenever the vehicle 10 stops running. In addition to the bar chart 90 and the line graph 92, the fuel consumption display also includes an average fuel economy display 94. This average is retained even when the vehicle 10 is not running, and it is only cleared when a reset button 96 is pushed. In addition, the average fuel economy display 94 provides a combination of textual and graphical information—i.e., the textual display relocates up or down to reflect changes in the average fuel consumption. As shown in FIG. 8, the fuel consumption display may also provide information such as the direction the vehicle 10 is traveling, the amount of time elapsed since the reset button 96 was pushed, and the distance traveled in that time.

As discussed above, the present invention includes a method for providing the vehicle operator with information through the vehicle information display 56. FIG. 9 shows a flow chart 98 illustrating the basic steps of a method in accordance with the present invention. At the outset, it is noted that at least some of the steps in the flow chart 98 may be performed in a difference sequence, including concurrently. In addition, the steps shown in the flow chart 98 are ongoing, and do not necessarily end at the end of the last step.

First, at block 100, a vehicle occupant chooses whether to display power flow information—see block 102—or fuel consumption information—see block 104. If fuel consumption information is chosen, then the appropriate information is calculated—see block 106—and displayed—see block 108. Of course, one or more of the controllers in the vehicle 10 may calculate various fuel consumption parameters on an ongoing basis, such that this information is merely transferred to the information display 56 when the mode switch 88 is actuated.

When the power flow information option is chosen—see block 102—the vehicle 10 is displayed in an iconic representation—see block 110. The iconic representation may be configured such as the representation 58 shown in FIG. 2. Based on signals it receives from various components of the vehicle 10, the VSC 50, the gateway 57, and/or the information display 56, then determines the direction of power flows for the engine 12, the motor 40, the generator 14, and the battery 46—see block 112. In addition to determining the direction of power flows, the VSC 50, the gateway 57, and/or the information display 56, also determines the magnitude of the power flows—see block 114.

At decision block 116, it is determined whether the configuration of the power flows is valid. As discussed above, this determination can include accounting for whether the DC/DC converter 54 is using current, and/or whether the determined power flows accurately represent the actual power flows. If the determined power flow configuration is not valid, the display defaults to the last valid configuration—see block 118. If the determined power flow configuration is valid, the various power flow indicators are displayed, including the direction and magnitude of each power flow—see block 120.

Although arrows having respective arrowheads and arrow thicknesses were shown in FIGS. 1-8 as one embodiment of the power flow indicators, other types of power flow indicators may be used. For example, at block 120, the power flow indicators may be displayed as a series of dots or dashes, rather than a continuous line. The diameter or width of the dots or dashes could then be increased to indicate the magnitude of the power flow. The brightness of the dots or dashes could be sequentially increased in one direction between the icons shown in the display. This could be used as an animated indicator of the direction of the power flow. Thus, any method that is effective to indicate both the magnitude and direction of the power flows can be used in accordance with the present invention.

While the best mode for carrying out the invention has been described in detail, those familiar with the art to which this invention relates will recognize various alternative designs and embodiments for practicing the invention as defined by the following claims.

What is claimed is:

1. A vehicle information display for a vehicle having components including an electric machine arrangement, an energy storage device, and vehicle drive wheels, the vehicle information display comprising:
an iconic representation of the vehicle, including a motor icon representing at least a portion of the electric machine arrangement, an energy storage device icon representing the energy storage device, and a vehicle drive wheels icon representing the vehicle drive wheels;
a first power flow indicator selectively displayed between the motor icon and the vehicle drive wheels icon to indicate a direction and relative magnitude of power being transferred between at least a portion of the electric machine arrangement and the vehicle drive wheels; and
a second power flow indicator selectively displayed between the motor icon and the energy storage device icon to indicate a direction and relative magnitude of power being transferred between at least a portion of the electric machine arrangement and the energy storage device.

2. The vehicle information display of claim 1, wherein at least one of the power flow indicators includes an arrow having an arrowhead and a thickness for respectively indicating the direction and relative magnitude of the power being transferred.

3. The vehicle information display of claim 1, further comprising a four-wheel drive indicator configured to be displayed when the vehicle is operating in a four-wheel drive mode.

4. The vehicle information display of claim 1, wherein the motor icon and the energy storage device icon have a respective textual label indicating what the respective icon represents.

5. The vehicle information display of claim 1, wherein the energy storage device includes one of a battery and a capacitor, and the energy storage device icon indicates a relative state of charge of the energy storage device.

6. The vehicle information display of claim 1, wherein the electric machine arrangement includes a generator, and the motor icon selectively represents the generator.

7. The vehicle information display of claim 1, the vehicle components further including an engine, and wherein the iconic representation of the vehicle further includes an engine icon representing the engine, the vehicle information display further comprising:
a third power flow indicator selectively displayed between the engine icon and the motor icon to indicate a direction and relative magnitude of power being transferred between the engine and at least a portion of the electric machine arrangement; and
a fourth power flow indicator selectively displayed between the engine icon and the vehicle drive wheels icon to indicate a direction and magnitude of power being transferred between the engine and the vehicle drive wheels.

8. The vehicle information display of claim 7, wherein one of the first, second, and third power flow indicators will be displayed only if at least one other of the first, second, and third power flow indicators is displayed.

9. The vehicle information display of claim 7, further comprising a textual indicator configured to indicate a state of operation of the vehicle corresponding to the transfer of power between the energy storage device, at least a portion of the electric machine arrangement, the engine, and the vehicle drive wheels.

10. The vehicle information display of claim 9, wherein the indicated state of operation is chosen from a plurality of vehicle operating states, including a hybrid drive state, an engine drive state, an electric drive state, a charging energy storage device state, an idle with charging state, and an idle state.

11. The vehicle information display of claim 10, wherein the electric machine arrangement includes a motor and a generator, and the textual indicator indicates:
the hybrid drive state when power is being transferred from the engine, and from the motor, to the vehicle drive wheels;
the engine drive state when power is being transferred from the engine to the vehicle drive wheels, and power is not being transferred from the motor to the vehicle drive wheels;
the electric drive state when power is being transferred from the motor to the vehicle drive wheels, and power is not being transferred from the engine to the vehicle drive wheels;
the charging energy storage device state when power is being transferred from the motor or the generator to the energy storage device; and
the idle with charging state when power is being transferred from the engine to the generator, and power is being transferred from the generator to the energy storage device.

12. The vehicle information display of claim 1, further comprising a mode switch configured to facilitate display of fuel consumption information when the first mode switch is actuated.

13. The vehicle information display of claim 12, wherein the fuel consumption information includes an average fuel economy display providing a combination of textual and graphical fuel consumption information.

14. The vehicle information display of claim 1, wherein each of the icons is identified with a first color when power is being transferred to or from a corresponding vehicle component.

15. The vehicle information display of claim 14, wherein at least one of the icons is identified with a second color when an anomaly exists in a corresponding vehicle component.

16. A method for displaying vehicle information, the vehicle including an electric machine arrangement, an energy storage device, and vehicle drive wheels, the method comprising:
displaying an iconic representation of the vehicle, including a motor icon representing at least a portion of the electric machine arrangement, an energy storage device icon representing the energy storage device, and a vehicle drive wheels icon representing the vehicle drive wheels;
selectively displaying a first power flow indicator between the motor icon and the vehicle drive wheels icon to indicate a direction and relative magnitude of power being transferred between at least a portion of the electric machine arrangement and the vehicle drive wheels; and
selectively displaying a second power flow indicator between the motor icon and the energy storage device icon to indicate a direction and relative magnitude of power being transferred between at least a portion of the electric machine arrangement and the energy storage device.

17. The method of claim 16, wherein displaying the power flow indicators includes respectively displaying for at least one power flow indicator an arrow having an arrowhead and a thickness, each respective arrowhead indicating a direction of power transfer, and each respective arrow thickness indicating a relative magnitude of power transfer.

18. The method of claim 16, wherein the electric machine arrangement includes a generator, and the motor icon selectively represents the generator.

19. The method of claim 16, the vehicle further including an engine, and wherein the iconic representation of the vehicle further includes an engine icon representing the engine, the method further comprising:
selectively displaying a third power flow indicator between the engine icon and the motor icon to indicate a direction and relative magnitude of power being transferred between the engine and at least a portion of the electric machine arrangement; and
selectively displaying a fourth power flow indicator between the engine icon and the vehicle drive wheels icon to indicate a direction and relative magnitude of power being transferred between the engine and the vehicle drive wheels.

20. The method of claim 19, wherein one of the first, second, and third power flow indicators will be displayed only if at least one other of the first, second, and third power flow indicators is displayed.

21. The method of claim 19, further comprising displaying a textual indicator indicative of a state of operation of the vehicle corresponding to the transfer of power between the energy storage device, the at least one electric machine, the engine, and the vehicle drive wheels.

22. The method of claim 16, further comprising displaying fuel consumption information when a mode switch is actuated.

23. The method of claim 22, wherein the fuel consumption information includes an average fuel economy display providing a combination of textual and graphical fuel consumption information.

24. The method of claim 16, further comprising identifying each of the icons with a first color when power is being transferred to or from a corresponding vehicle component.

25. The method of claim 24, further comprising identifying at least one of the icons with a second color when an anomaly exists in a corresponding vehicle component.

26. A vehicle, comprising:
an electric machine arrangement;
an energy storage device;
vehicle drive wheels;
a vehicle information display including a motor icon representing at least a portion of the electric machine arrangement, an energy storage device icon representing the energy storage device, a vehicle drive wheels icon representing the vehicle drive wheels, and power flow indicators configured to be selectively displayed to indicate a direction and relative magnitude of power being transferred between the energy storage device, the vehicle drive wheels, and at least a portion of the electric machine arrangement; and
at least one controller configured to receive signals from the electric machine arrangement and the energy storage device, and to control operation of the vehicle information display.
